(19) United States
(12) Patent Application Publication
(10) Pub. No.: US 2026/0100518 A1
(43) Pub. Date: Apr. 9, 2026

(54) MULTI-FUNCTIONAL ASSEMBLY, WIRELESS COMMUNICATION DEVICE, AND DISPLAY PANEL

(71) Applicant: Yungu (Gu’an) Technology Co., Ltd., Langfang (CN)

(72) Inventors: Huan-Chu HUANG, Taiwan (CN); Shuang CUI, Langfang (CN); Jie WU, Langfang (CN)

(73) Assignee: Yungu (Gu’an) Technology Co., Ltd., Langfang (CN)

(21) Appl. No.: 19/417,282

(22) Filed: Dec. 11, 2025

Related U.S. Application Data
(63) Continuation of application No. PCT/CN2023/134222, filed on Nov. 27, 2023.

(30) Foreign Application Priority Data
Jun. 13, 2023 (CN) 202310699579.4

(51) Int. Cl. H01Q 15/14; H01Q 1/22; H01Q 1/24; H01Q 3/46

(52) U.S. Cl. CPC H01Q 15/148; H01Q 1/2258; H01Q 1/243; H01Q 3/46

(57) ABSTRACT

Embodiments of the present application provide a multi-functional assembly, a wireless communication device, and a display panel. The wireless communication device includes: a substrate; a functional layer provided on the substrate and including a plurality of multi-functional units; a shielding layer provided on a side of the functional layer facing away from a display surface of the wireless communication device; and a control assembly provided on the substrate and including a radio-frequency circuit and a control circuit, where the radio-frequency circuit is connected to the multi-functional unit to control the multi-functional unit to transmit and receive a wireless signal from an antenna, and the control circuit is connected to the multi-functional unit to change an electrical load of the multi-functional unit to control the multi-functional unit to reflect a signal.

### CROSS-REFERENCE TO RELATED APPLICATIONS

The present application is a continuation of International Application No. PCT/CN2023/134222, filed on Nov. 27, 2023, which claims priority to Chinese Patent Application No. 202310699579.4, entitled “MULTI-FUNCTIONAL ASSEMBLY, WIRELESS COMMUNICATION DEVICE, AND DISPLAY PANEL” and filed on Jun. 13, 2023, which is incorporated herein by reference in its entirety.

### FIELD

The present application relates to the field of display devices, and in particular, to a wireless communication device and a display panel.

### BACKGROUND

Wireless communication devices (such as mobile phones and smart watches) are rapidly evolving in functionality, while there are increasingly high requirements for the appearance and wireless communication performance of the apparatuses on the market. How to improve the communication performance of wireless communication devices thus has become an urgent problem to be resolved.

### SUMMARY

Embodiments of the present application provide a multi-functional assembly, a wireless communication device, and a display panel, which are intended to improve the communication performance of the wireless communication device.

An embodiment of a first aspect of the present application provides a wireless communication device. The wireless communication device includes: a substrate; a functional layer provided on the substrate and including a plurality of multi-functional units; a shielding layer provided on a side of the functional layer facing the substrate; and a control assembly provided on the substrate and including a radio-frequency circuit and a control circuit, where the radio-frequency circuit is connected to the multi-functional unit to control the multi-functional unit to transmit and receive a wireless signal from an antenna, and the control circuit is connected to the multi-functional unit to change an electrical load of the multi-functional unit to control the multi-functional unit to reflect a wireless signal.

An embodiment of a second aspect of the present application further provides a display panel. The display panel includes: a substrate; a functional layer provided on the substrate and including a plurality of multi-functional units; a shielding layer provided on a side of the functional layer facing the substrate; and a plurality of connection lines provided on the substrate and respectively connected to the multi-functional units, and a control circuit is connected to the multi-functional unit through the connection line and controls the multi-functional unit to reflect a signal, and a radio-frequency circuit is connected to the multi-functional unit through the connection line and controls the multi-functional unit to transmit and receive a wireless signal from an antenna.

An embodiment of a third aspect of the present application further provides a multi-functional assembly. The multi-functional assembly includes: a functional layer including a plurality of multi-functional units; a shielding layer provided on a side of the functional layer; and a control assembly including a radio-frequency circuit and a control circuit, where the radio-frequency circuit is connected to the multi-functional unit to control the multi-functional unit to transmit and receive a wireless signal from an antenna, and the control circuit is connected to the multi-functional unit to change an electrical load of the multi-functional unit to control the multi-functional unit to reflect a wireless signal.

In the wireless communication device according to the embodiments of the present application, the wireless communication device includes the substrate, the functional layer, the shielding layer, and the control assembly. The multi-functional unit is provided within the functional layer, and the multi-functional unit is connected to the radio-frequency circuit and the control circuit of the control assembly, and the control circuit can change the electrical load of the multi-functional unit to control the multi-functional unit to reflect the wireless signal, and the radio-frequency circuit can control the multi-functional unit to transmit and receive the wireless signal from the antenna. The multi-functional unit has both a reflection function and functions of the antenna, which can effectively improve the wireless communication performance of the wireless communication device. The shielding layer is located on a side of the functional layer facing away from a display surface of the wireless communication device, and the shielding layer can shield the wireless signal to enable the wireless signal to be reflected from the multi-functional unit, and can reduce the impact of the wireless signal on parts and components inside the wireless communication device.

### BRIEF DESCRIPTION OF THE DRAWINGS

FIG. 1 is a schematic diagram of a structure of a wireless communication device according to an embodiment of a first aspect of the present application;

FIG. 2 is a schematic diagram of a structure of a display panel of a wireless communication device according to an embodiment of the first aspect of the present application;

FIG. 3 is a cross-sectional view taken along line A-A in FIG. 2;

FIG. 4 is a cross-sectional view taken along line B-B in FIG. 2;

FIG. 5 is a schematic diagram of a circuit structure of a wireless communication device according to an embodiment of the first aspect of the present application;

FIG. 6 is a schematic diagram of a structure of a display panel of a wireless communication device according to another embodiment of the first aspect of the present application;

FIG. 7 is a cross-sectional view taken along line C-C in FIG. 6;

FIG. 8 is a cross-sectional view taken along line D-D in FIG. 6;

FIG. 9 is a schematic diagram of a structure of a display panel of a wireless communication device according to still another embodiment of the first aspect of the present application;

FIG. 10 is a schematic diagram of a structure of a display panel of a wireless communication device according to yet another embodiment of the first aspect of the present application;

FIG. 11 is a schematic diagram of a circuit structure of a wireless communication device according to another embodiment of the first aspect of the present application;

FIG. 12 is a schematic diagram of a structure of a wireless communication device according to another embodiment of the first aspect of the present application;

FIG. 13 is a cross-sectional view of a circuit board of a wireless communication device according to another embodiment of the first aspect of the present application in an unfolded state;

FIG. 14 is a cross-sectional view of a circuit board of the wireless communication device according to another embodiment of the first aspect of the present application in a bent state;

FIG. 15 is a schematic diagram of a structure of a display panel of a wireless communication device according to still yet another embodiment of the first aspect of the present application;

FIG. 16 is a schematic diagram of a structure of a display panel of a wireless communication device according to still yet another embodiment of the first aspect of the present application;

FIG. 17 is a schematic diagram of a structure of a display panel of a wireless communication device according to still yet another embodiment of the first aspect of the present application;

FIG. 18 is a schematic diagram of a structure of a display panel of a wireless communication device according to still yet another embodiment of the first aspect of the present application;

FIG. 19 is a schematic diagram of a structure of a display panel of a wireless communication device according to still yet another embodiment of the first aspect of the present application;

FIG. 20 is a schematic diagram of a structure of a display panel of a wireless communication device according to still yet another embodiment of the first aspect of the present application;

FIG. 21 is a schematic diagram of a circuit structure of a wireless communication device according to still another embodiment of the first aspect of the present application;

FIG. 22 is a partial cross-sectional view of a wireless communication device according an embodiment of the first aspect of the present application;

FIG. 23 is a partial cross-sectional view of a wireless communication device according another embodiment of the first aspect of the present application;

FIG. 24 is a schematic diagram of a structure of a display panel of a wireless communication device according to still yet another embodiment of the first aspect of the present application;

FIG. 25 is a schematic diagram of a structure of a display panel of a wireless communication device according to still yet another embodiment of the first aspect of the present application;

FIG. 26 is a schematic diagram of a structure of a display panel of a wireless communication device according to still yet another embodiment of the first aspect of the present application;

FIG. 27 is a schematic diagram of a structure of a display panel of a wireless communication device according to still yet another embodiment of the first aspect of the present application;

FIG. 28 is a cross-sectional view taken along line B-B in FIG. 2 in another example; and

FIG. 29 is a schematic diagram of a structure of a wireless communication device according to still another embodiment of the first aspect of the present application.

### DETAILED DESCRIPTION OF THE EMBODIMENTS

With the development of display technologies and wireless communication technologies, there are increasingly high requirements for the communication performance of wireless communication devices. Intelligent reflecting surface (IRS), as an important communication design that has currently attracted extensive attention and research investment, can change the direction and number of reflected beams incident from a wireless signal source by regulating amplitudes and phases of electrical signals on a plurality of reflecting units on the intelligent reflecting surface (i.e., by changing electrical loads of the reflecting units), such as by regulating the reflected beam, which is used as one reflected beam or split into a plurality of reflected beams, to be directed toward one or more communication targets, thereby facilitating a significant improvement in the wireless communication quality. The IRS may be installed on interior or exterior walls of a building. In addition, an antenna is also an important functional component on a wireless communication device that is used for transmitting and receiving wireless signals.

The IRS is generally a structure of three layers, that is, a reflecting unit on the top layer, which is a conductor structure and is configured to reflect a wireless signal; a metal plate, such as a copper plate, below the reflecting unit, which is configured to shield and reflect a wireless signal; and a control circuit board provided on a side of the metal plate facing away from the reflecting unit, with the control circuit board being connected to the reflecting unit and configured to regulate a signal amplitude and phase for each reflecting unit, to control the direction and number of reflected beams. However, since all the three layers in this structure are visually non-transparent to human eyes, the IRS is also visually non-transparent to human eyes.

In order to improve the communication performance of the wireless communication device, the present application enables the IRS to be integrated onto the wireless communication device, and allows a reflecting unit in the IRS and an antenna unit in an antenna to be reused therebetween, to improve the wireless communication performance of the wireless communication device.

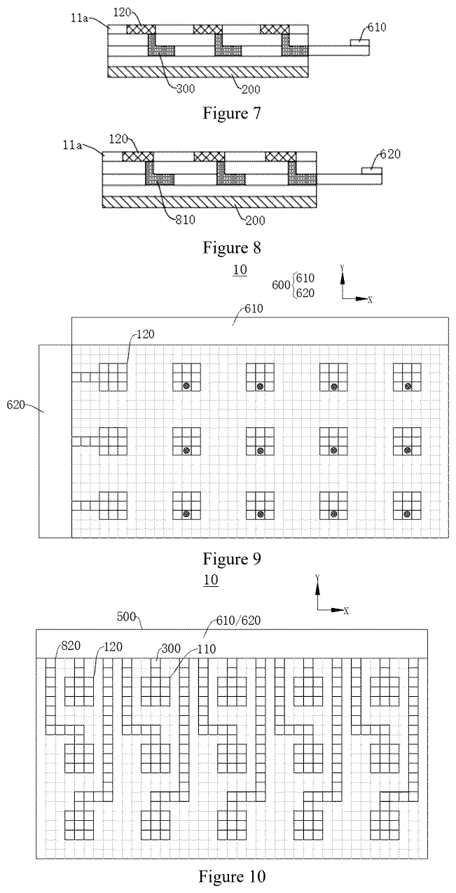

In order to better understand the present application, a multi-functional assembly, a wireless communication device, and a display panel according to embodiments of the present application will be described below in detail with reference to FIG. 1 to FIG. 28.

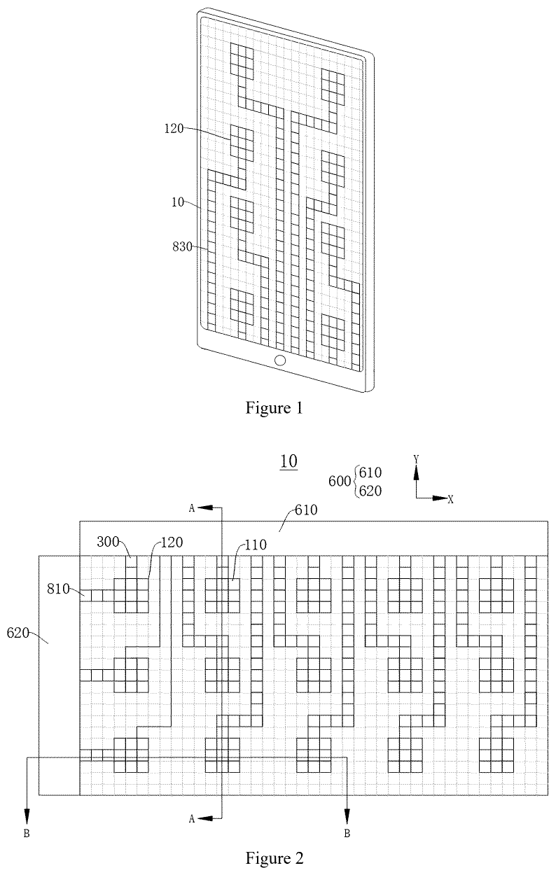

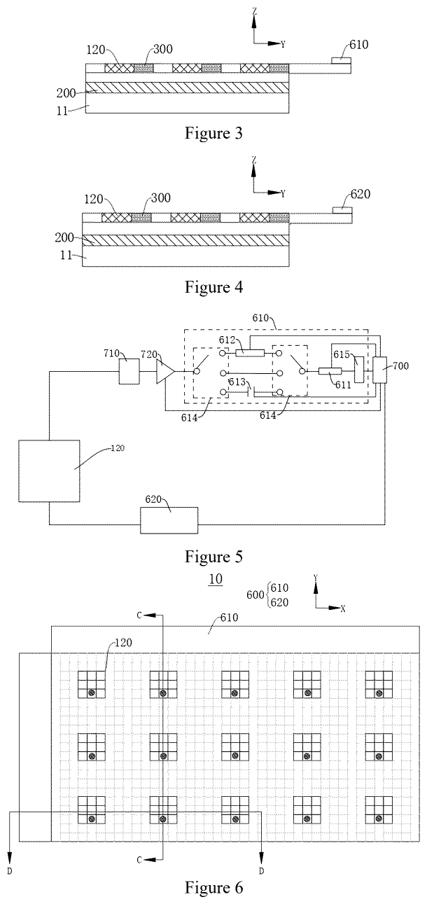

Referring to FIG. 1 to FIG. 4, FIG. 1 is a schematic diagram of a structure of a wireless communication device according to an embodiment of the present application, FIG. 2 is a schematic diagram of a structure of a display panel 10 of a wireless communication device according to an embodiment of the present application, FIG. 3 is a cross-sectional view taken along line A-A in FIG. 2, and FIG. 4 is a cross-sectional view taken along line B-B in FIG. 2.

As shown in FIG. 1 to FIG. 4, an embodiment of a first aspect of the present application provides a wireless communication device. The wireless communication device includes a substrate 11, a functional layer 100, a shielding layer 200, and a control assembly 600. The functional layer 100 is provided on the substrate 11 and includes a plurality of multi-functional units 120. The shielding layer 200 is provided on a side of the functional layer 100 facing the substrate 11. The control assembly 600 is provided on the substrate 11 and includes a radio-frequency circuit 620 and a control circuit 610. The radio-frequency circuit 620 is connected to the multi-functional unit 120 to control the multi-functional unit 120 to transmit and receive a wireless signal from an antenna. The control circuit 610 is connected to the multi-functional unit 120 to change an electrical load of the multi-functional unit 120 to control the multi-functional unit to reflect a signal.

In the wireless communication device according to this embodiment of the present application, the wireless communication device includes the substrate 11, the functional layer 100, the shielding layer 200, and the control assembly 600. The multi-functional unit 120 is provided within the functional layer 100, and the multi-functional unit 120 is connected to the radio-frequency circuit 620 and the control circuit 610 of the control assembly 600, and the control circuit 610 can change the electrical load of the multi-functional unit 120 to control the multi-functional unit to reflect a wireless signal, and the radio-frequency circuit 620 can control the multi-functional unit 120 to transmit and receive the wireless signal from the antenna. The multi-functional unit 120 has both a reflection function and functions of the antenna, which can effectively improve the wireless communication performance of the wireless communication device. The shielding layer 200 is provided on a side of the functional layer 100 facing away from a display surface of the wireless communication device, and the shielding layer 200 can shield and reflect the wireless signal to enable the wireless signal to be reflected from the multi-functional unit 120, and can reduce the impact of the wireless signal on parts and components inside the wireless communication device.

In an embodiment, the shielding layer 200 can be used as a metal plate in the above-described IRS to shield and reflect the wireless signal.

The wireless communication device in this embodiment of the present application includes, but is not limited to, devices having a display function, such as a mobile phone, a wireless wearable device, a personal digital assistant (PDA), a tablet computer, an e-book reader, a television, an access control system, a smart fixed-line telephone, a console, an electronic display board, or a display board with a transparent base substrate.

In an embodiment, the multi-functional unit 120 is located in an active area of the wireless communication device, and the multi-functional unit 120 and the shielding layer 200 are both transparent structure layers. For example, the multi-functional unit 120 and the shielding layer 200 have a light transmittance greater than or equal to 50%, to mitigate the impact of the multi-functional unit 120 on the display effect of the wireless communication device. In some other embodiments, when the multi-functional unit 120 is provided in a non-active area of the wireless communication device, the light transmittance of the multi-functional unit 120 is not limited.

The display surface of the wireless communication device is a light exit surface of the wireless communication device, and the functional layer 100 is provided closer to the light exit surface of the wireless communication device than the shielding layer 200.

When wireless signals are incident through the light exit surface of the wireless communication device, the wireless signals are first incident into the functional layer 100 and are reflected by the multi-functional units 120 in the functional layer 100. Part of the wireless signals are incident into the shielding layer 200 through a gap between adjacent multi-functional units 120 and are shield by the shielding layer 200.

In an embodiment, the wireless communication device includes the display panel 10. The substrate 11, the functional layer 100, and the shielding layer 200 may be provided on the display panel 10, to integrate the multi-functional unit 120 and the shielding layer 200 onto the display panel 10, thereby simplifying the structure of the wireless communication device. In an embodiment, at least part of the control circuit 610 and the radio-frequency circuit 620 may also be provided within the display panel 10. In one embodiment, the wireless communication device may further include a circuit board 500 connected to the display panel 10, and the control circuit 610 and the radio-frequency circuit 620 may be provided on the circuit board 500.

In an embodiment, each multi-functional unit 120 is connected to at least one control circuit 610, and different multi-functional units 120 are connected to different control circuits 610, enabling separate control of the respective multi-functional units 120 through the respective control circuits 610. In an embodiment, each multi-functional unit 120 is connected to at least one radio-frequency circuit 620, and different multi-functional units 120 are connected to different radio-frequency circuits 620, enabling separate control of the respective multi-functional units 120 through the respective radio-frequency circuits 620.

In an embodiment, orthographic projections of two or more multi-functional units 120 on the substrate 11 are within an orthographic projection of the shielding layer 200 on the substrate 11.

In some embodiments, as shown in FIG. 2, the wireless communication device further includes a reflecting module. The reflecting module includes a plurality of reflecting units 110. The reflecting unit 110 is connected to the control circuit 610, and the control circuit 610 is configured to change an electrical load of the reflecting unit 110. In an embodiment, the reflecting module includes a combination of the plurality of reflecting units 110. In an embodiment, each reflecting unit 110 and each multi-functional unit 120 are connected to different control circuits 610. For example, when the reflecting unit 110 and the multi-functional unit 120 are each connected to one control circuit 610, the number of control circuits 610 is a sum of the number of reflecting units 110 and the number of multi-functional units 120. The reflecting units 110 are provided in a one-to-one correspondence with the control circuits 610, and the multi-functional units 120 are provided in a one-to-one correspondence with the control circuits 610. In these embodiments, adding the separate reflecting unit 110 for reflecting the wireless signal can further improve the wireless communication performance of the wireless communication device.

In an embodiment, when the wireless communication device includes the display panel 10, the reflecting module (i.e., the reflecting unit 110) may be provided within the display panel 10.

In an embodiment, an orthographic projection of the reflecting unit 110 on the substrate 11 is within the orthographic projection of the shielding layer 200 on the substrate 11, and the shielding layer 200 can further shield a wireless signal not reflected by the reflecting unit 110.

In some embodiments, the plurality of reflecting units 110 within the reflecting module are distributed in an array, and the multi-functional unit 120 is located on at least one side in a peripheral direction of the reflecting module. In other words, the multi-functional unit 120 reused as an antenna and a reflecting surface is provided on the peripheral side of the separate reflecting module for reflecting the wireless signal. The multi-functional unit 120 is provided closer to an edge of the wireless communication device, to mitigate the impact of the multi-functional unit 120 on the display effect of the wireless communication device. As shown in FIG. 2, the multi-functional unit 120 is located on a side of the plurality of reflecting units 110 in a first direction.

In an embodiment, at least part of the multi-functional units 120 are provided in the same layer as the reflecting unit 110. For example, all of the multi-functional units 120 are provided in the same layer as the reflecting unit 110, and the reflecting unit 110 is also provided in the functional layer 100, enabling the multi-functional unit 120 and the reflecting unit 110 to be prepared and formed in the same process step, thereby simplifying the preparation process of the wireless communication device.

In an embodiment, as shown in FIG. 2, for the multi-functional unit 120 and the reflecting unit 110 that are provided in the same layer, a size and shape of an orthographic projection of the multi-functional unit on the substrate 11 are the same as a size and shape of an orthographic projection of the reflecting unit 110 on the substrate 11, to simplify the shape and arrangement of the multi-functional unit 120 and the reflecting unit 110 that are provided in the same layer.

In an embodiment, the reflecting unit 110 is provided in the active area of the wireless communication device, and the light transmittance of the reflecting unit 110 is greater than or equal to 50%, to mitigate the impact of the reflecting unit 110 on the display effect of the wireless communication device. In other embodiments, when the reflecting unit 110 is provided in the non-active area of the wireless communication device, the light transmittance of the reflecting unit 110 is not limited.

In some embodiments, as shown in FIG. 1 to FIG. 5, the wireless communication device further includes a baseband 700. The baseband 700 is configured to control an electrical connection or disconnection between the multi-functional unit 120 and the control circuit 610. When the multi-functional unit 120 is reused as a reflecting surface assembly and is configured to reflect a wireless signal, the baseband 700 controls the multi-functional unit 120 and the control circuit 610 to be electrically connected to each other. When the multi-functional unit 120 is reused as an antenna, the baseband 700 controls the multi-functional unit 120 and the control circuit 610 to be electrically disconnected from each other. “Connected” and “disconnected” herein refer to electrical connection and disconnection. When the multi-functional unit 120 is electrically connected to the control circuit 610, the control circuit 610 can change the electrical load of the multi-functional unit 120. When the multi-functional unit 120 is electrically disconnected from the control circuit 610, the control circuit 610 cannot change the electrical load of the multi-functional unit 120.

The baseband 700 may control the multi-functional unit 120 and the control circuit 610 to be electrically connected to or disconnected from each other in various ways. For example, the baseband 700 controls the multi-functional unit 120 and the control circuit 610 to be electrically connected to or disconnected from each other in stages according to a preset time sequence and a time length. For example, the baseband 700 controls the multi-functional unit 120 and the control circuit 610 to be electrically connected to each other for a period of time t1, further controls the multi-functional unit 120 and the control circuit 610 to be disconnected from each other for a period of time t2, and then controls the multi-functional unit 120 and the control circuit 610 to be electrically connected to each other for the period of time t1, and so on. The period of time t1 and the period of time t2 may be the same or different.

In an embodiment, when the wireless communication device includes the circuit board 500 connected to the display panel 10, the baseband 700 may be provided on the circuit board 500. The control circuit 610, the radio-frequency circuit 620, and the baseband 700 may be provided on the same circuit board 500, or at least two of the control circuit 610, the radio-frequency circuit 620, and the baseband 700 may be provided on the same circuit board 500, or the control circuit 610, the radio-frequency circuit 620, and the baseband 700 may be provided on different circuit boards 500.

In some other embodiments, the baseband 700 is further configured to obtain a first radio-frequency operating current of the multi-functional unit 120 and a second radio-frequency operating current of at least one reflecting unit 110, and the baseband 700 is further configured to control the multi-functional unit 120 and the control circuit 610 to be disconnected from each other when an absolute value of a current difference between the first radio-frequency operating current and the second radio-frequency operating current is greater than or equal to a first preset threshold.

When the multi-functional unit 120 is reused as the antenna, a radio-frequency operating current in the multi-functional unit 120 is different from a radio-frequency operating current in the separate reflecting unit 110 for reflecting a wireless signal. In these embodiments, the baseband 700 can obtain the first radio-frequency operating current and the second radio-frequency operating current, and when the absolute value of the difference between the first radio-frequency operating current and the second radio-frequency operating current is greater than the first preset threshold, which indicates an excessively large difference between the radio-frequency operating currents of the multi-functional unit 120 and the reflecting unit 110, the multi-functional unit 120 is reused as the antenna, and the baseband 700 controls the multi-functional unit 120 and the control circuit 610 to be electrically disconnected from each other, and the multi-functional unit 120 is in an operating mode of the antenna.

The first preset threshold may be set according to a user's actual use requirements. For example, the first preset threshold may be determined based on a dynamic range of a radio-frequency device to which the multi-functional unit 120 is connected, a dynamic range of a radio-frequency device to which the reflecting unit 110 is connected, and the sensitivity of the baseband platform 700, provided that it can be determined that the multi-functional unit 120 is currently reused as the antenna rather than the reflecting surface when the absolute value of the radio-frequency current difference is greater than or equal to the first preset threshold.

In an embodiment, the baseband 700 is further configured to control the multi-functional unit 120 and the control circuit 610 to be electrically connected to each other when the absolute value of the current difference between the first radio-frequency operating current and the second radio-frequency operating current is less than the first preset threshold. In one embodiment, when the absolute value of the current difference is less than the first preset threshold, which indicates little difference between the operating current of the multi-functional unit 120 and the operating current of the reflecting unit 110, the multi-functional unit 120 is reused as the reflecting surface and reflects a wireless signal together with the reflecting unit 110, and the multi-functional unit 120 and the control circuit 610 are electrically connected to each other, and then the control circuit 610 can control the operating state of the multi-functional unit 120 when the multi-functional unit is reused as the reflecting surface.

In an embodiment, the second radio-frequency operating current obtained by the baseband 700 is a radio-frequency operating current of a reflecting unit 110 adjacent to the multi-functional unit 120. In other words, the baseband 700 is configured to obtain the first radio-frequency operating current of the multi-functional unit 120 and the second radio-frequency operating current of the reflecting unit 110 adjacent to the multi-functional unit 120. Determining whether the multi-functional unit 120 is reused as the reflecting surface based on the radio-frequency operating current of the reflecting unit 110 adjacent to the multi-functional unit 120 can improve the determination accuracy, thereby improving the control accuracy of the baseband 700.

In some embodiments, the wireless communication device further includes a low noise amplifier 720. The low noise amplifier 720 is connected between the multi-functional unit 120 and/or the reflecting unit 110 and the baseband 700, to mitigate the impact of a noise signal on the control accuracy. In an embodiment, the baseband 700 is further configured to control the electrical connection or disconnection between the control circuit 610 and the multi-functional unit 120 through the low noise amplifier 720. The low noise amplifier 720 may be connected between the multi-functional unit 120 and the baseband 700, or the low noise amplifier 720 is connected between the reflecting unit 110 and the baseband 700, or the low noise amplifier 720 is connected both between the multi-functional unit 120 and the baseband 700 and between the reflecting unit 110 and the baseband 700.

In an embodiment, the wireless communication device further includes a filter 710 connected between the multi-functional unit 120 and the low noise amplifier 720.

The control circuit 610 may be provided in various ways. In some embodiments, as shown in FIG. 5, the control circuit 610 includes a variable resistor 611. The variable resistor 611 is connected between the multi-functional unit 120 and/or the reflecting unit 110 and the baseband 700. When the control circuit 610 is configured to change the electrical load of the multi-functional unit 120, the variable resistor 611 is connected between the multi-functional unit 120 and the baseband 700, and an amplitude of the electrical load of the multi-functional unit 120 when the multi-functional unit is used as the reflecting surface is adjusted by adjusting a resistance value of the variable resistor 611. When the control circuit 610 is configured to change the electrical load of the reflecting unit 110, the variable resistor 611 is connected between the reflecting unit 110 and the baseband 700, and an amplitude of the reflecting unit 110 can be adjusted by changing a resistance value of the variable resistor 611. In an embodiment, the baseband 700 is connected to the variable resistor 611, and the baseband 700 can adjust the resistance value of the variable resistor 611.

In an embodiment, when the wireless communication device includes the low noise amplifier 720, the variable resistor 611 may be connected between the low noise amplifier 720 and the baseband 700.

In an embodiment, when the wireless communication device includes the circuit board 500 and the display panel 10, the variable resistor 611 may be provided on the display panel 10 or the circuit board 500.

In an embodiment, the control circuit 610 further includes a variable capacitor 613 and/or a variable inductor 612. The variable capacitor 613 and/or the variable inductor 612 is connected between the multi-functional unit 120 and the variable resistor 611; and/or the variable capacitor 613 and/or the variable inductor 612 is connected between the reflecting unit 110 and the variable resistor 611. When the control circuit 610 is configured to change the electrical load of the multi-functional unit 120, the variable capacitor 613 and/or the variable inductor 612 is connected between the multi-functional unit 120 and the variable resistor 611. When the control circuit 610 is configured to change the electrical load of the reflecting unit 110, the variable capacitor 613 and/or the variable inductor 612 is connected between the reflecting unit 110 and the variable resistor 611. Providing the variable capacitor 613 and/or the variable inductor 612 within the control circuit 610 can change the characteristics such as an electrical phase of the multi-functional unit 120 and/or the reflecting unit 110. In an embodiment, the baseband 700 is connected to the variable capacitor 613, and the baseband 700 can adjust a capacitance value of the variable capacitor 613. In an embodiment, the baseband 700 is connected to the variable inductor 612, and the baseband 700 can adjust a capacitance value of the variable inductor 612.

In an embodiment, the control circuit 610 further includes a second switch 614. The second switch 614 is configured to control a specific circuit through which the multi-functional unit 120 and/or the reflecting unit 110 is connected to the variable resistor 611. For example, the second switch 614 is configured to control the multi-functional unit 120 and/or the reflecting unit 110 to be directly connected to the variable resistor 611, or the second switch 614 is configured to control the multi-functional unit 120 and/or the reflecting unit 110 to be connected to the variable resistor 611 through the variable capacitor 613, or the second switch 614 is configured to control the multi-functional unit 120 and/or the reflecting unit 110 to be connected to the variable resistor 611 through the variable inductor 612.

For example, the second switch 614 includes two single-pole multi-throw switches. One end of the second switch 614 is connected to the multi-functional unit 120 and/or the reflecting unit 110, and the other end of the second switch 614 has three lines provided thereon. One of the lines is directly connected to the variable resistor 611, another line is connected to the variable resistor 611 through the variable capacitor 613, and the other line is connected to the variable resistor 611 through the variable inductor 612. By controlling the connection relationship within the second switch 614, the specific line through which the multi-functional unit 120 and/or the reflecting unit 110 is connected to the variable resistor 611 can be determined.

In an embodiment, the control circuit 610 further includes a downconverter 615. The downconverter 615 is connected between the variable resistor 611 and the baseband 700.

In an embodiment, the wireless communication device includes a control line 300, and the multi-functional unit 120 is connected to the control circuit 610 through the control line 300. In an embodiment, the wireless communication device further includes a radio-frequency line 810, and the multi-functional unit 120 is connected to the radio-frequency circuit 620 through the radio-frequency line 810. As shown in FIG. 2 to FIG. 4, the multi-functional unit 120 is provided in the same layer as the control line 300 and/or the radio-frequency line 810. In one embodiment, as shown in FIG. 6 to FIG. 8, the multi-functional unit 120 is provided in a different layer from the control line 300 and/or the radio-frequency line 810. In one embodiment, as shown in FIG. 9, the radio-frequency line 810 is provided in the same layer as the multi-functional unit 120, while the control line 300 is provided in a different layer from the multi-functional unit 120. In FIG. 9, both the radio-frequency line 810 and the multi-functional unit 120 can be observed in the same layer, while the control line 300 cannot be observed. In other embodiments, it is also possible that the control line 300 is provided in the same layer as the multi-functional unit 120, while the radio-frequency line 810 is provided in a different layer from the multi-functional unit 120.

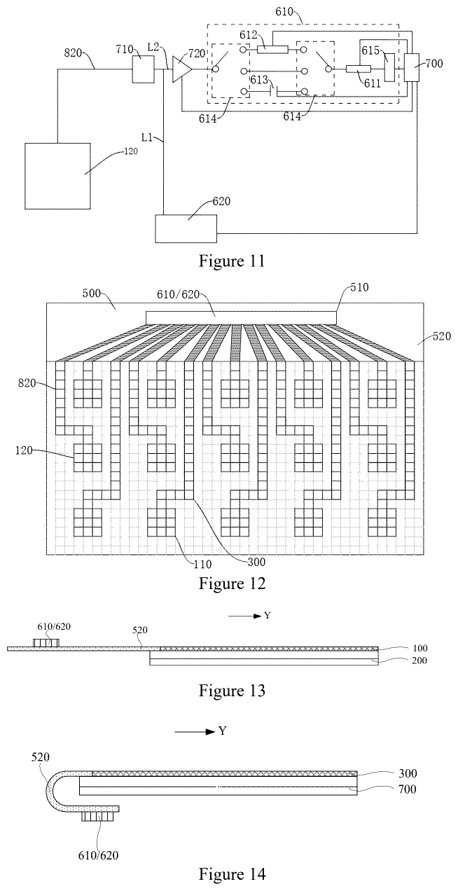

In some embodiments, as shown in FIG. 10 and FIG. 11, the wireless communication device further includes a multi-functional control feeder line 820. One end of the multi-functional control feeder line 820 is connected to the multi-functional unit 120, and the other end of the multi-functional control feeder line 820 is connected to the radio-frequency circuit 620 and the control circuit 610. Combining two lines connected to the radio-frequency circuit 620 and the control circuit 610 into one multi-functional control feeder line 820 can simplify the arrangement of lines inside the wireless communication device and the structure of the wireless communication device.

In an embodiment, the multi-functional control feeder line 820 may be provided in the same layer as the multi-functional unit 120, to reduce the number of layer structures of the wireless communication device.

In one embodiment, In an embodiment, the multi-functional control feeder line 820 may be provided in a different layer from the multi-functional unit 120, and the arrangement of the multi-functional unit 120 and the arrangement of the multi-functional control feeder line 820 do not affect each other.

In some embodiments, the wireless communication device further includes a control line 300 connecting the reflecting unit 110 and the control circuit 610. In other words, the control line 300 may further be configured to connect the reflecting unit 110 and the control circuit 610. The control line 300 is provided in the same layer as the multi-functional control feeder line 820, enabling the control line 300 and the multi-functional control feeder line 820 to be prepared and formed in the same process step, thereby simplifying the preparation process of the wireless communication device. In some other embodiments, the control line 300 may also be provided in a different layer from the multi-functional control feeder line 820, to facilitate more flexible routing of the control line 300 and the multi-functional control feeder line 820.

In an embodiment, the multi-functional unit 120 to which the radio-frequency line 810 is connected and the multi-functional unit 120 to which the multi-functional control feeder line 820 is connected may be the same or different. To simplify the structure of the wireless communication device, the multi-functional units 120 connected to the radio-frequency line 810 and the multi-functional control feeder line 820 may be different from each other. In an embodiment, the multi-functional unit 120 to which the radio-frequency line 810 is connected further has a control line 300 connected thereto. In other words, among the plurality of multi-functional units 120, one part of the multi-functional units 120 are connected to the radio-frequency circuit 620 and the control circuit 610 through the multi-functional control feeder line 820, and another part of the multi-functional units 120 are connected to the radio-frequency circuit 620 through the radio-frequency line 810 and to the control circuit 610 through the control line 300.

In an embodiment, at least two of the radio-frequency line 810, the control line 300, and the multi-functional control feeder line 820 are provided in the same layer, to simplify the preparation process of the wireless communication device.

In some embodiments, as described above, the wireless communication device further includes the circuit board 500, and the radio-frequency circuit 620 and the control circuit 610 are both provided on the circuit board 500. In an embodiment, as shown in FIG. 11, a first signal line L1 and a second signal line L2 are provided on the circuit board 500. The first signal line L1 connects the multi-functional control feeder line 820 and the radio-frequency circuit 620, and the second signal line L2 connects the multi-functional control feeder line 820 and the control circuit 610. In an embodiment, the multi-functional control feeder line 820 is provided on the substrate 11. For example, the multi-functional control feeder line 820 may be provided inside the substrate 11 of the display panel 10, and the radio-frequency circuit 620 and the control circuit 610 may be provided on the circuit board 500. The multi-functional control feeder line 820 inside the display panel 10 is connected to the radio-frequency circuit 620 and the control circuit 610 respectively through the first signal line L1 and the second signal line L2 on the circuit board 500.

In an embodiment, as shown in FIG. 12 to FIG. 14, the circuit board 500 may be a flexible circuit board, and the circuit board 500 is bent and the control circuit 610 and the radio-frequency circuit 620 can be provided on a non-display side of the wireless communication device by bending the flexible circuit board. As such, the proportion of the display panel 10 on the wireless communication device can be increased.

Different numbers of functional layers 100 may be provided. For example, as shown in FIG. 2 to FIG. 10, one functional layer 100 is provided, and two or more multi-functional units 120 distributed in an array are provided within the functional layer 100. In an embodiment, one shielding layer 200 is provided.

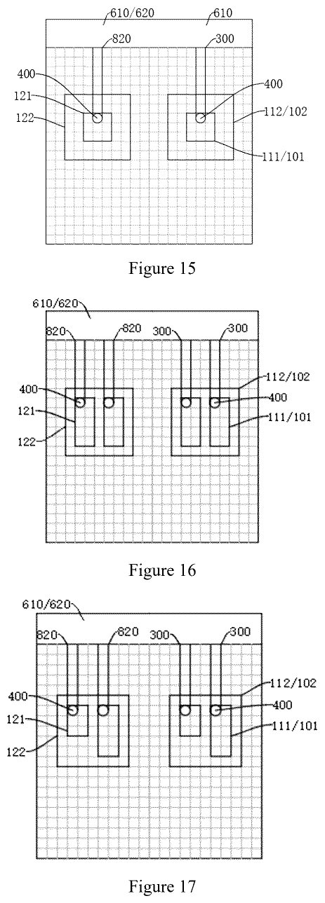

In some other embodiments, as shown in FIG. 15, two or more functional layers 100 are provided, and at least two multi-functional units 120 located in different functional layers 100 have different areas of orthographic projections on the substrate 11.

In these embodiments, providing at least two functional layers 100 and providing multi-functional units 120 of different sizes within different functional layers 100 enable the multi-functional units 120 to reflect wireless signals in different frequency bands, or enable the multi-functional units 120 to transmit and receive wireless signals in different frequency bands to and from an antenna, thereby further improving the wireless communication performance of the wireless communication device.

In an embodiment, the reflecting unit 110 is also provided in the functional layer 100. The reflecting unit 110 is provided in each of two or more functional layers 100, and at least two reflecting units 110 located in different functional layers 100 have different areas of orthographic projections. Reflecting units 110 of different sizes can reflect wireless signals in different frequency bands, thereby further improving the wireless communication performance of the wireless communication device. Only one group of two multi-functional units 120 located in different functional layers 100 and one group of two reflecting units 110 located in different functional layers 100 are shown in FIG. 15. In an embodiment, a plurality of groups of multi-functional units 120 and a plurality of groups of reflecting units 110 may also be provided in different functional layers 100. In other words, two or more multi-functional units 120 and two or more reflecting units 110 may be provided in the same functional layer 100.

In an embodiment, two or more multi-functional units 120 in the same functional layer 100 have the same area of orthographic projections on the substrate 11, that is, the two or more multi-functional units 120 in the same functional layer 100 have the same size, and the two or more multi-functional units 120 in the same functional layer 100 can reflect wireless signals in the same frequency band, thereby enhancing the ability to reflect the wireless signals in the same frequency band.

In an embodiment, two or more reflecting units 110 in the same functional layer 100 have the same area of orthographic projections on the substrate 11, that is, the two or more reflecting units 110 in the same functional layer 100 have the same size, and the two or more reflecting units 110 in the same functional layer 100 can reflect wireless signals in the same frequency band, thereby enhancing the efficiency of reflecting the wireless signals in the same frequency band.

In an embodiment, for the reflecting unit 110 and the multi-functional unit 120 that are provided in the same functional layer 100, the area of the orthographic projection of the reflecting unit on the substrate 11 is the same as the area of the orthographic projection of the multi-functional unit on the substrate 11, to simplify the structure of the wireless communication device. In addition, the ability to reflect the wireless signals in the same frequency band can also be enhanced.

In some embodiments, as shown in FIG. 15, when two or more functional layers 100 are provided, the two or more functional layers 100 include a first functional layer 101 and a second functional layer 102, that is, one of the two or more functional layers 100 is the first functional layer 101, and the other is the second functional layer 102. The multi-functional unit 120 includes a first multi-functional unit 121 located in the first functional layer 101 and a second multi-functional unit 122 located in the second functional layer 102. The first functional layer 101 is located on a side of the second functional layer 102 facing the display surface of the display panel 10, and an area of an orthographic projection of the first multi-functional unit 121 on the substrate 11 is less than an area of an orthographic projection of the second multi-functional unit 122 on the substrate 11.

In these embodiments, since the first multi-functional unit 121 is located on the side of the second multi-functional unit 122 facing the display surface of the display panel 10, and the size of the first multi-functional unit 121 is less than the size of the second multi-functional unit 122, wireless signals in a plurality of frequency bands can be reflected, and the display panel 10 is able to regulate reflected signals for wireless signals in different frequency bands.

In an embodiment, the reflecting unit 110 includes a first reflecting unit 111 located in the first functional layer 101 and a second reflecting unit 112 located in the second functional layer 102, and an area of an orthographic projection of the first reflecting unit 111 on the substrate 11 is less than an area of an orthographic projection of the second reflecting unit 112 on the substrate 11. At least part of the second reflecting unit 112 is not shielded by the first reflecting unit 111, and thus the second reflecting unit 112 can also reflect a wireless signal. In addition, since the size of the first reflecting unit 111 is different from the size of the second reflecting unit 112, wireless signals in a plurality of frequency bands can be reflected, and the display screen 10 is able to regulate reflected signals for wireless signals in different frequency bands.

In an embodiment, an orthographic projection of each first multi-functional unit 121 on the substrate 11 at least partially overlaps an orthographic projection of each second multi-functional unit 122 on the substrate 11. As such, the overall distribution area of the two or more multi-functional units 120 can be reduced, and wireless signals in a plurality of frequency bands can be reflected. The orthographic projection of each first multi-functional unit 121 on the substrate 11 at least partially overlapping the orthographic projection of each second multi-functional unit 122 on the substrate 11 includes: first multi-functional units 121 being provided in a one-to-one correspondence with second multi-functional units 122, and the orthographic projection of each first multi-functional unit 121 on the substrate 11 at least partially overlapping the orthographic projection of each second multi-functional unit 122 on the substrate 11; or two or more first multi-functional units 121 being provided corresponding to the same second multi-functional unit 122, or the same first multi-functional unit 121 being provided corresponding to two or more second multi-functional units 122, provided that the orthographic projection of each first multi-functional unit 121 on the substrate 11 can at least partially overlap the orthographic projection of at least one second multi-functional unit 122 on the substrate 11, or the orthographic projection of each second multi-functional unit 122 on the substrate 11 can at least partially overlap the orthographic projection of at least one first multi-functional unit 121 on the substrate 11.

In an embodiment, an orthographic projection of each first reflecting unit 111 on the substrate 11 at least partially overlaps an orthographic projection of each second reflecting unit 112 on the substrate 11. As such, the overall distribution area of the two or more reflecting units 110 and thus the size of the reflecting surface assembly can be reduced, and wireless signals in a plurality of frequency bands can be reflected. The orthographic projection of each first reflecting unit 111 on the substrate 11 at least partially overlapping the orthographic projection of each second reflecting unit 112 on the substrate 11 includes: first reflecting units 111 being provided in a one-to-one correspondence with second reflecting units 112, and the orthographic projection of each first reflecting unit 111 on the substrate 11 at least partially overlapping the orthographic projection of each second reflecting unit 112 on the substrate 11; or two or more first reflecting units 111 being provided corresponding to the same second reflecting unit 112, or the same first reflecting unit 111 being provided corresponding to two or more second reflecting units 112, provided that the orthographic projection of each first reflecting unit 111 on the substrate 11 can at least partially overlap the orthographic projection of at least one second reflecting unit 112 on the substrate 11, or the orthographic projection of each second reflecting unit 112 on the substrate 11 can at least partially overlap the orthographic projection of at least one first reflecting unit 111 on the substrate 11.

In an embodiment, the first reflecting unit 111 and the first multi-functional unit 121 have the same shape and size, and the second reflecting unit 112 and the second multi-functional unit 122 have the same shape and size, to simplify the structure of the wireless communication device.

In an embodiment, a correspondence between the number of first reflecting units 111 and the number of second reflecting units 112 is the same as a correspondence between the number of first multi-functional units 121 and the number of second multi-functional units 122. For example, when the first reflecting units 111 are provided in a one-to-one correspondence with the second reflecting units 112, the first multi-functional units 121 are provided in a one-to-one correspondence with the second multi-functional units 122.

In an embodiment, the wireless communication device further includes a connection portion 400. The connection portion 400 is provided in an overlapping area between the first multi-functional unit 121 and the second multi-functional unit 122, and one end of the connection portion 400 is connected to the first multi-functional unit 121 and the second multi-functional unit 122, and the other end of the connection portion 400 is connected to the control circuit 610 and/or the radio-frequency circuit 620. In an embodiment, the connection portion 400 is reused as part of at least one of the multi-functional control feeder line 820, the control line 300, and the radio-frequency line 810.

In these embodiments, providing the connection portion 400 in the overlapping area between the first multi-functional unit 121 and the second multi-functional unit 122 and enabling the connection portion 400 to extend in a thickness direction of the display panel 10 to be connected to both the first multi-functional unit 121 and the second multi-functional unit 122 can simplify the structure of the connection portion 400.

In an embodiment, the connection portion 400 is further provided in an overlapping area between the first reflecting unit 111 and the second reflecting unit 112, and one end of the connection portion 400 is connected to the first multi-functional unit 121 and the second multi-functional unit 122, and the other end of the connection portion 400 is connected to the control line 300. Enabling the connection portion 400 to extend in the thickness direction of the display panel 10 to be connected to both the first reflecting unit 111 and the second reflecting unit 112 can simplify the structure of the connection portion 400.

In an embodiment, as shown in FIG. 15, the first multi-functional units 121 may be provided in a one-to-one correspondence with the second multi-functional units 122. In one embodiment, as shown in FIG. 16, since the size of the first multi-functional unit 121 is less than the size of the second multi-functional unit 122, two or more first multi-functional units 121 may be provided corresponding to the same second multi-functional unit 122.

In some embodiments, as shown in FIG. 16, the two or more first multi-functional units 121 are provided corresponding to the same second multi-functional unit 122, and in the corresponding second multi-functional unit 122 and two or more first multi-functional units 121, the orthographic projections of the two or more first multi-functional units 121 on the substrate 11 are within the orthographic projection of the same second multi-functional unit 122 on the substrate 11.

In these embodiments, since the size of the first multi-functional unit 121 is relatively small, providing the two or more first multi-functional units 121 corresponding to the same second multi-functional unit 122 can increase the number of first multi-functional units 121 that can be provided, thereby improving the wireless communication performance of the first functional layer 101. The orthographic projections of the two or more first multi-functional units 121 on the substrate 11 are within the orthographic projection of the same second multi-functional unit 122 on the substrate 11, which makes the arrangement of the first multi-functional units 121 and the second multi-functional unit 122 more regular, thereby facilitating preparation and formation.

In an embodiment, the first reflecting units 111 may be provided in a one-to-one correspondence with the second reflecting units 112. In one embodiment, since the size of the first reflecting unit 111 is less than the size of the second reflecting unit 112, two or more first reflecting units 111 are provided corresponding to the same second reflecting unit 112.

In some embodiments, two or more first reflecting units 111 are provided corresponding to the same second reflecting unit 112, and in the corresponding second reflecting unit 112 and two or more first reflecting units 111, the orthographic projections of the two or more first reflecting units 111 on the substrate 11 are within the orthographic projection of the same second reflecting unit 112 on the substrate 11.

In these embodiments, since the size of the first reflecting unit 111 is relatively small, providing the two or more first reflecting units 111 corresponding to the same second reflecting unit 112 can increase the number of first reflecting units 111 that can be provided, thereby improving the wireless communication performance of the first functional layer 101. The orthographic projections of the two or more first reflecting units 111 on the substrate 11 are within the orthographic projection of the same second reflecting unit 112 on the substrate 11, which makes the arrangement of the first reflecting units 111 and the second reflecting unit 112 more regular, thereby facilitating preparation and formation.

In an embodiment, as shown in FIG. 17, in the corresponding second multi-functional unit 122 and two or more first multi-functional units 121, the two or more first multi-functional units 121 have different areas of projections on the substrate 11, and the two or more first multi-functional units 121 corresponding to the same second multi-functional unit 122 can reflect wireless signals in different frequency bands, or transmit and receive wireless signals in different frequency bands to and from an antenna, thereby further improving the wireless communication performance of the display panel 10.

In an embodiment, as shown in FIG. 17, in the corresponding second reflecting unit 112 and two or more first reflecting units 111, the two or more first reflecting units 111 have different areas of projections on the substrate 11, and the two or more first reflecting units 111 corresponding to the same second reflecting unit 112 can reflect wireless signals in different frequency bands, thereby further improving the wireless communication performance of the display panel 10.

In some other embodiments, as shown in FIG. 16, in the corresponding second multi-functional unit 122 and two or more first multi-functional units 121, the two or more first multi-functional units 121 may also have the same area of projections on the substrate 11. In some other embodiments, in the corresponding second reflecting unit 112 and two or more first reflecting units 111, the two or more first reflecting units 111 may also have the same area of projections on the substrate 11.

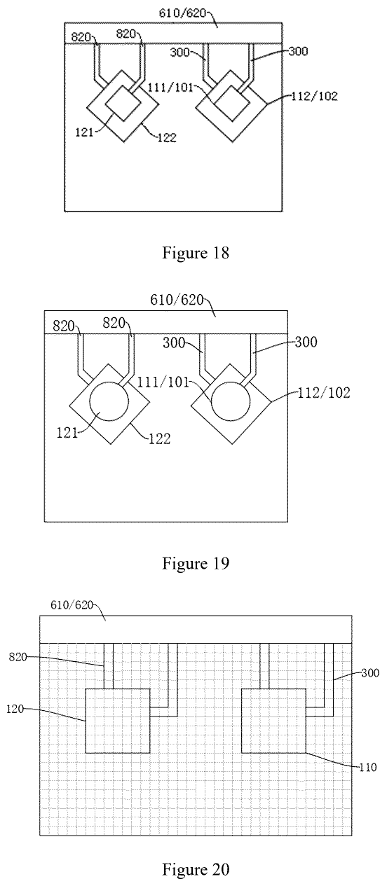

In an embodiment, as shown in FIG. 18 and FIG. 19, the orthographic projection of the first multi-functional unit 121 on the substrate 11 and the orthographic projection of the second multi-functional unit 122 on the substrate 11 may have the same or different shapes. For example, the orthographic projection of the second multi-functional unit 122 on the substrate 11 has a rectangular shape, and the orthographic projection of the first multi-functional unit 121 on the substrate 11 may have a rectangular or circular shape.

In an embodiment, as shown in FIG. 18 and FIG. 19, the orthographic projection of the first reflecting unit 111 on the substrate 11 and the orthographic projection of the second reflecting unit 112 on the substrate 11 may have the same or different shapes. For example, the orthographic projection of the second reflecting unit 112 on the substrate 11 has a rectangular shape, and the orthographic projection of the first reflecting unit 111 on the substrate 11 may have a rectangular or circular shape.

Only one second multi-functional unit 122 and one second reflecting unit 112 are shown in FIG. 15 to FIG. 19. In other embodiments, a plurality of second multi-functional units 122 are provided, and the plurality of second multi-functional units 122 are spaced apart from each other, and/or a plurality of second reflecting units 112 are provided, and the plurality of second reflecting units 112 are spaced apart from each other.

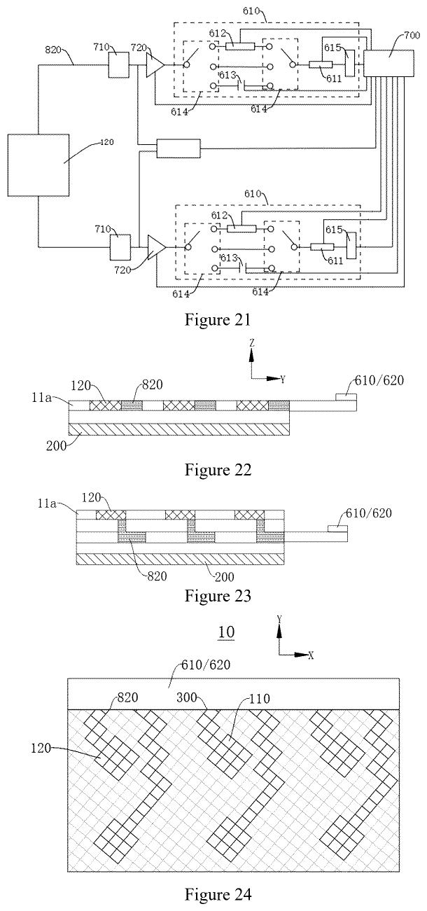

In some embodiments, as shown in FIG. 1 to FIG. 19, the same multi-functional unit 120 may be connected to the same control circuit 610, or as shown in FIG. 20 and FIG. 21, the same multi-functional unit 120 may be connected to two or more control circuits 610. Through the two or more control circuits 610, different electrical loads of the multi-functional unit 120 can be changed, and then amplitude adjustment, phase adjustment, etc. can be performed on the multi-functional unit 120. In an embodiment, the same reflecting unit 110 may be connected to the same control circuit 610, or the same reflecting unit 110 may be connected to two or more control circuits 610. Through the two or more control circuits 610, different electrical loads of the reflecting unit 110 can be changed, and then amplitude adjustment, phase adjustment, etc. can be performed on the reflecting unit 110.

In an embodiment, when the same multi-functional unit 120 is connected to two or more control circuits 610, the same multi-functional unit 120 has two or more control lines 300 connected thereto, and the multi-functional unit 120 is connected to the respective control circuits 610 through the respective control lines 300. In one embodiment, when the same multi-functional unit 120 has two or more radio-frequency lines 810 connected thereto, the multi-functional unit 120 is connected to respective radio-frequency circuits 620 through the two or more radio-frequency lines 810. In one embodiment, when the same multi-functional unit 120 has two or more multi-functional control feeder lines 820 connected thereto, the multi-functional unit 120 is connected to the respective control circuits 610 through the two or more multi-functional control feeder lines 820. When the same multi-functional unit 120 has two or more control lines 300, two or more radio-frequency lines 810, or two or more multi-functional control feeder lines 820 connected thereto, the two or more control lines 300, the two or more radio-frequency lines 810, or the two or more multi-functional control feeder lines 820 are spaced apart from each other on the same multi-functional unit 120, to alleviate interference between the two or more control lines 300 or the two or more multi-functional control feeder lines 820.

In an embodiment, when the same reflecting unit 110 is connected to two or more control circuits 610, the same reflecting unit 110 has two or more control lines 300 connected thereto, and the two or more control lines 300 are spaced apart from each other on the same reflecting unit 110, to alleviate interference between the two or more control lines 300.

In some embodiments, as shown in FIG. 22 and FIG. 23, the display panel 10 further includes a signal line layer 11a. As shown in FIG. 22, the multi-functional unit 120 and the multi-functional control feeder line 820 may be provided in the same layer and both located in the signal line layer 11a, to simplify the structure of the display panel 10. In one embodiment, as described above, when the multi-functional unit 120 and the multi-functional control feeder line 820 are provided in different layers, as shown in FIG. 23, the multi-functional unit 120 is provided in the signal line layer 11a, and the multi-functional control feeder line 820 is provided in another conductive layer. In one embodiment, the multi-functional control feeder line 820 is provided in the signal line layer 11a, and the multi-functional unit 120 is provided in another conductive layer.

In an embodiment, the multi-functional control feeder line 820 may be provided in a conductive layer on a side of the functional layer 100 facing away from the shielding layer 200. For example, the multi-functional control feeder line 820 is provided in the signal line layer 11a, and the signal line layer 11a may be located on the side of the functional layer 100 facing away from the shielding layer 200. In one embodiment, the multi-functional control feeder line 820 may be provided in a conductive layer between the functional layer 100 and the shielding layer 200. For example, the multi-functional control feeder line 820 is provided in the signal line layer 11a, and the signal line layer 11a may be located between the functional layer 100 and the shielding layer 200. In an embodiment, the reflecting unit 110 and the multi-functional unit 120 are provided in the same layer, and the control line 300 connected to the reflecting unit 110 may be provided in the same layer as the multi-functional control feeder line 820.

The signal line layer 11a may be provided in various ways. For example, as shown in FIG. 1, FIG. 2, FIG. 6, FIG. 9, FIG. 10, FIG. 15 to FIG. 17, and FIG. 20 to FIG. 23, the signal line layer 11a includes a grid-patterned metal wiring, and at least part of the grid-patterned metal wiring is reused as at least one of the multi-functional unit 120, the multi-functional control feeder line 820, the reflecting unit 110, the control line 300, and the radio-frequency line 810. The grid-patterned metal wiring includes a first signal line extending in a first direction and a second signal line extending in a second direction. A plurality of first signal lines and a plurality of second signal lines intersect to form a grid pattern.

When a part of the metal wiring is reused as at least one of the multi-functional unit 120, the multi-functional control feeder line 820, the reflecting unit 110, the control line 300, and the radio-frequency line 810, the part of the metal wiring is insulated from metal wirings at other positions, to avoid a short-circuited connection between at least one of adjacent multi-functional units 120, adjacent multi-functional control feeder lines 820, adjacent reflecting units 110, adjacent control lines 300, and adjacent radio-frequency lines 810.

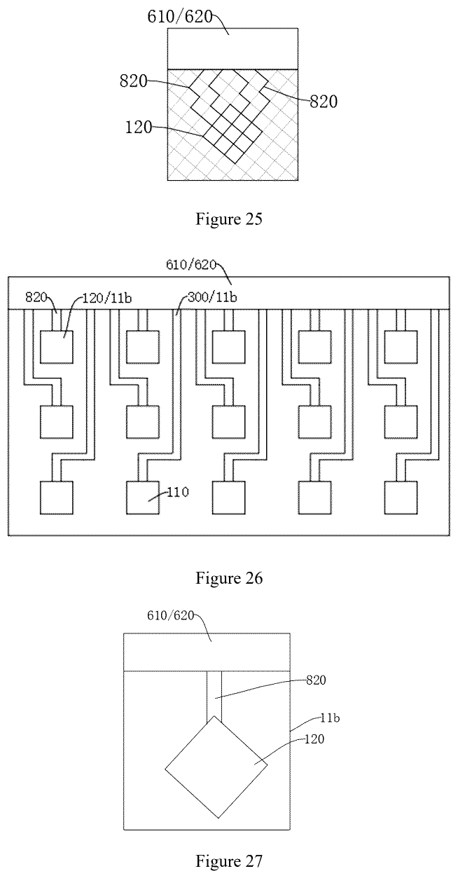

In an embodiment, as shown in FIG. 24, an extension direction of the grid-patterned metal wiring intersects a length direction of the display panel 10. The extension direction of the grid-patterned metal wiring may be an extension direction of the first signal line, or may be an extension direction of the second signal line. The display panel 10 includes a first side edge and a second side edge, and two first sides and two second sides are alternately connected to enclose the display panel 10. A length of the first side edge is greater than a length of the second side edge, and an extension direction of the first side edge may be the length direction of the display panel 10. The extension direction of the grid-patterned metal wiring intersecting the length direction of the display panel 10 means the extension direction of the first signal line and/or the second signal line intersecting the extension direction of the first side edge, which can reduce the impact of the grid-patterned metal wiring on the display effect of the display panel 10. As shown in FIG. 25, when the extension direction of the grid-patterned metal wiring intersects the length direction of the display panel 10, the multi-functional unit 120 may also be connected to two multi-functional control feeder lines 820.

In some other embodiments, as shown in FIG. 18 and FIG. 19, and FIG. 26 and FIG. 27, the display panel 10 further includes a light-transmissive conductive layer 11b. A material of the light-transmissive conductive layer 11b includes a light-transmissive conductive material such as indium tin oxide, to improve the light transmittance of the light-transmissive conductive layer 11b. The light-transmissive conductive layer 11b has the characteristics of high light transmittance and conducting electricity.

In an embodiment, at least one of the multi-functional unit 120, the multi-functional control feeder line 820, the reflecting unit 110, the control line 300, the radio-frequency line 810, and the shielding layer 200 is provided in the light-transmissive conductive layer 11b, to reduce the impact of the at least one of the multi-functional unit 120, the multi-functional control feeder line 820, the reflecting unit 110, the control line 300, the radio-frequency line 810, and the shielding layer 200 on the display effect of the display panel 10.

In an embodiment, the light-transmissive conductive layer 11b includes a first conductive layer 11b1 and a second conductive layer 11b2 that are stacked. At least one of the multi-functional unit 120 and the reflecting unit 110 is provided in the first conductive layer 11b1, and the shielding layer 200 is provided in the second conductive layer 11b2.

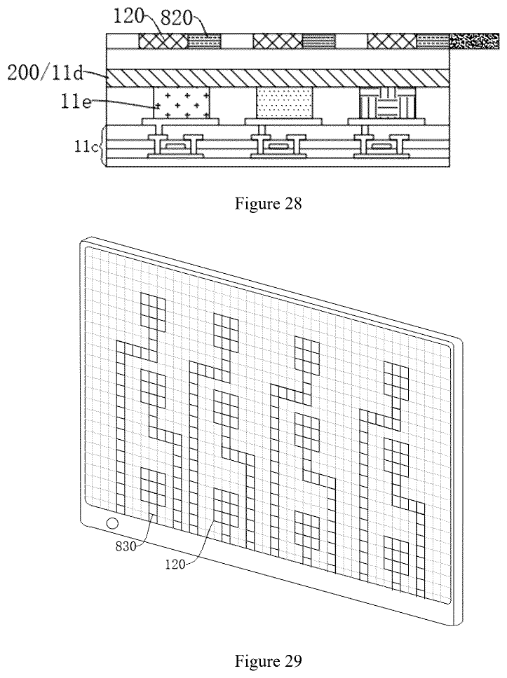

In some embodiments, as shown in FIG. 28, the substrate 11 includes an array substrate 11c and a common electrode layer 11d. The common electrode layer 11d is located on a side of the array substrate 11c facing the display surface of the display panel 10, and the common electrode layer 11d is reused as the shielding layer 200. Enabling an original layer structure of the display panel 10 to be reused as the shielding layer 200 can simplify the structure of the display panel 10.

In an embodiment, the array substrate 11c includes a base substrate and a drive circuit provided on the base substrate. In an embodiment, a planarization layer, a pixel electrode layer, and a pixel definition layer are provided on the substrate 11. The pixel electrode layer includes a plurality of pixel electrodes distributed in an array on the planarization layer, and the pixel definition layer is located on a side of the pixel electrode layer facing away from the planarization layer. The pixel definition layer includes a pixel defining portion and a pixel opening enclosed by the pixel defining portion, and a light-emitting unit 11e may be provided in the pixel opening. The common electrode layer 11d is provided on a side of the pixel defining portion and the light-emitting unit 11e facing away from the planarization layer.

In an embodiment, an encapsulation layer and a touch layer are further provided on a side of the common electrode layer 11d facing away from the pixel definition layer, and the multi-functional unit 120 and the reflecting unit 110 may be provided in the touch layer, to further simplify the structure of the display panel 10.

An embodiment of a second aspect of the present application further provides a display panel 10. The display panel 10 may be a display panel 10 of the wireless communication device in any one of the above-described embodiments.

In an embodiment, as shown in FIG. 1 to FIG. 29, the display panel 10 includes a substrate 11, a functional layer 100, a shielding layer 200, and a plurality of connection lines. The functional layer 100 is provided on the substrate 11 and includes a plurality of multi-functional units 120. The shielding layer 200 is provided on a side of the functional layer 100 facing away from a display surface of the display panel 10. The plurality of connection lines are provided on the substrate 11 and respectively connected to the multi-functional units 120, and a control circuit 610 may be connected to the multi-functional unit 120 through the connection line and change an electrical load of the multi-functional unit 120 to control the multi-functional unit to reflect a wireless signal, and a radio-frequency circuit 620 may be connected to the multi-functional unit 120 through the connection line and control the multi-functional unit 120 to transmit and receive a wireless signal from an antenna.

In these embodiments, the display panel 10 is provided with the multi-functional unit 120, and the multi-functional unit 120 may be connected to the control circuit 610 through the connection line, and the control circuit 610 changes the electrical load of the multi-functional unit 120 to control the multi-functional unit to reflect the wireless signal. In other words, the multi-functional unit 120 is reused as a reflecting surface structure. The multi-functional unit 120 may be further connected to the radio-frequency circuit 620 through the connection line, and the radio-frequency circuit 620 can control the multi-functional unit 120 to transmit and receive the wireless signal from the antenna. In other words, the multi-functional unit 120 is reused as an antenna structure.

In an embodiment, the connection line may include the above-described multi-functional control feeder line 820, and the multi-functional unit 120 is connected to both the radio-frequency circuit 620 and the control circuit 610 through the multi-functional control feeder line 820. In one embodiment, the connection line may include the above-described control line 300 and radio-frequency line 810, and the multi-functional unit 120 is connected to the radio-frequency circuit 620 through the radio-frequency line 810, and the multi-functional unit 120 is connected to the control circuit 610 through the control line 300. In an embodiment, the display panel 10 further includes a reflecting unit 110, and the control line 300 may also be connected to the reflecting unit 110 and the control circuit 610.

In an embodiment, the display panel 10 may be an organic light-emitting diode display panel, a liquid crystal display panel, or a micro light-emitting diode display panel.

An embodiment of a third aspect of the present application further provides a multi-functional assembly. The multi-functional assembly includes a functional layer 100, a shielding layer 200, and a control assembly 600. The functional layer 100 includes a plurality of multi-functional units 120. The shielding layer 200 is provided on a side of the functional layer 100 facing a substrate 11. The control assembly 600 is provided on the substrate 11 and includes a radio-frequency circuit 620 and a control circuit 610. The radio-frequency circuit 620 is connected to the multi-functional unit 120 to control the multi-functional unit 120 to transmit and receive a wireless signal from an antenna. The control circuit 610 is connected to the multi-functional unit 120 to change an electrical load of the multi-functional unit 120 to control the multi-functional unit to reflect a signal. The multi-functional unit 120 has both a reflection function and functions of an antenna, which can effectively improve the wireless communication performance of the multi-functional assembly.

The functional layer 100, the shielding layer 200, and the control assembly 600 are provided as described above, and details will not be repeated herein.

1. A wireless communication device, comprising:
a substrate;
a functional layer provided on the substrate and comprising a plurality of multi-functional units;
a shielding layer provided on a side of the functional layer facing the substrate; and
a control assembly provided on the substrate and comprising a radio-frequency circuit and a control circuit, wherein the radio-frequency circuit is connected to the multi-functional unit to control the multi-functional unit to transmit and receive a wireless signal from an antenna, and the control circuit is connected to the multi-functional unit to change an electrical load of the multi-functional unit to control the multi-functional unit to reflect a wireless signal.

2. The wireless communication device according to claim 1, further comprising a reflecting module, the reflecting module comprising a plurality of reflecting units, wherein the reflecting unit is connected to the control circuit, and the control circuit is further configured to change an electrical load of the reflecting unit.

3. The wireless communication device according to claim 2, wherein the plurality of reflecting units within the reflecting module are distributed in an array, and the multi-functional unit is located on at least one side in a peripheral direction of the reflecting module.

4. The wireless communication device according to claim 3, wherein at least part of the multi-functional units are provided in the same layer as the reflecting unit.

5. The wireless communication device according to claim 4, wherein the multi-functional unit and the reflecting unit that are provided in the same layer have the same size and shape of orthographic projections on the substrate.

6. The wireless communication device according to claim 2, further comprising a baseband configured to control an electrical connection or disconnection between the multi-functional unit and the control circuit.

7. The wireless communication device according to claim 6, wherein the baseband is further configured to obtain a first radio-frequency operating current of the multi-functional unit and a second radio-frequency operating current of at least one reflecting unit, and control the multi-functional unit and the control circuit to be electrically disconnected from each other when an absolute value of a current difference between the first radio-frequency operating current and the second radio-frequency operating current is greater than or equal to a first preset threshold.

8. The wireless communication device according to claim 7, wherein the baseband is configured to obtain the first radio-frequency operating current of the multi-functional unit and the second radio-frequency operating current of the reflecting unit adjacent to the multi-functional unit.

9. The wireless communication device according to claim 7, wherein the baseband is further configured to control the multi-functional unit and the control circuit to be electrically connected to each other when the absolute value of the current difference is less than the first preset threshold.

10. The wireless communication device according to claim 6, further comprising a low noise amplifier connected between the multi-functional unit or the reflecting unit and the baseband.

11. The wireless communication device according to claim 10, further comprising a filter provided between the reflecting unit and the low noise amplifier.

12. The wireless communication device according to claim 6, wherein the control circuit comprises a variable resistor connected between the multi-functional unit or the reflecting unit and the baseband.

13. The wireless communication device according to claim 12, wherein the control circuit further comprises a variable capacitor and a variable inductor connected between the reflecting unit and the variable resistor.

14. The wireless communication device according to claim 13, wherein the control circuit comprises a second switch, wherein the second switch is configured to control the multi-functional unit and the reflecting unit to be directly connected to the variable resistor, or the second switch is configured to control the multi-functional unit and the reflecting unit to be connected to the variable resistor through the variable capacitor, or the second switch is configured to control the multi-functional unit and the reflecting unit to be connected to the variable resistor through the variable inductor.

15. The wireless communication device according to claim 12, wherein the control circuit further comprises a downconverter connected between the variable resistor and the baseband.

16. The wireless communication device according to claim 2, further comprising a multi-functional control feeder line, wherein one end of the multi-functional control feeder line is connected to at least one multi-functional unit, and the other end of the multi-functional control feeder line is connected to the radio-frequency circuit and the control circuit.

17. The wireless communication device according to claim 16, further comprising:
a control line connecting the reflecting unit and the control circuit; and
a radio-frequency line connected between at least one multi-functional unit and the radio-frequency circuit, wherein at least two of the radio-frequency line, the control line, and the multi-functional control feeder line are provided in the same layer.

18. The wireless communication device according to claim 16, further comprising a circuit board on which the radio-frequency circuit and the control circuit are both provided, wherein the multi-functional control feeder line is provided on the substrate, and the circuit board has a first signal line and a second signal line provided thereon, the first signal line connecting the multi-functional control feeder line and the radio-frequency circuit, and the second signal line connecting the multi-functional control feeder line and the control circuit.

19. A display panel, comprising:
a substrate;
a functional layer provided on the substrate and comprising a plurality of multi-functional units;
a shielding layer provided on a side of the functional layer facing the substrate; and
a plurality of connection lines provided on the substrate and respectively connected to the multi-functional units,
a control circuit connected to the multi-functional unit through the connection line to change an electrical load of the multi-functional unit to control the multi-functional unit to reflect a wireless signal, and
a radio-frequency circuit connected to the multi-functional unit through the connection line and controls the multi-functional unit to transmit and receive a wireless signal from an antenna.

20. A multi-functional assembly, comprising:
a functional layer comprising a plurality of multi-functional units;
a shielding layer provided on a side of the functional layer; and
a control assembly comprising a radio-frequency circuit and a control circuit, wherein the radio-frequency circuit is connected to the multi-functional unit to control the multi-functional unit to transmit and receive a wireless signal from an antenna, and the control circuit is connected to the multi-functional unit to change an electrical load of the multi-functional unit to control the multi-functional unit to reflect a wireless signal.
